(19) United States
(12) Patent Application Publication
(10) Pub. No.: US 2021/0326388 A1
(43) Pub. Date: Oct. 21, 2021

(54) ELECTRONIC DEVICE FOR PROVIDING INFOGRAPHICS, AND METHOD THEREOF

(71) Applicant: Samsung Electronics Co., Ltd., Suwon-si, Gyeonggi-do (KR)

(72) Inventors: Kyungjun LEE, Suwon-si (KR); Soonhong KWON, Suwon-si (KR); Haemi YOON, Suwon-si (KR)

(21) Appl. No.: 17/268,767

(22) PCT Filed: Jun. 21, 2019
(86) PCT No.: PCT/KR2019/007522

§ 371 Date: Feb. 16, 2021

(30) Foreign Application Priority Data
Aug. 27, 2018 (KR) 10-2018-0100093

(51) Int. Cl. G06F 16/901; G06F 16/9038; G06N 20/00; G06F 16/583

(52) U.S. Cl. CPC G06F 16/9024; G06F 16/583; G06N 20/00; G06F 16/9038

(57) ABSTRACT

Disclosed is an electronic device. The electronic device may: receive first data including content from an external electronic device; identify whether a first infographic is included in the first data; transmit, to a server, a message requesting analysis of the first infographic when the first infographic is included in the first data; receive, from the server, second data including a second infographic corrected from the first infographic; and display content including the second infographic.

### TECHNICAL FIELD

Embodiments disclosed in the disclosure relate to an electronic device for providing infographics and a method thereof.

### BACKGROUND ART

With the development of the network, an electronic device may receive content including many pieces of information from an external electronic device and may provide a user with the received content. The user may obtain various pieces of information by means of content. The content may be provided in various forms. For example, the electronic device may display content including infographics on its display to provide the user with statistics. The infographics may be formed with various types of figures, for example, a bar graph, a pie graph, or a broken-line graph.

### DISCLOSURE

### Technical Problem

An external electronic device may generate infographics formed with a figure based on a data value (e.g., a number). In a process where the external electronic device generates infographics, there may occur a distortion where a data value and a shape of a figure forming infographics are not matched to each other. An electronic device may receive content including the distorted infographics from the external electronic device and may provide a user with the distorted infographics. The distorted infographics may cause confusion to the user who receives information.

Various embodiments disclosed in the disclosure may provide an apparatus and a method for more accurately providing a user with infographics provided from an external electronic device.

### Technical Solution

In accordance with an aspect of the disclosure, an electronic device is provided. The electronic device may include a display, a wireless communication circuitry, a processor operatively connected with the display and the wireless communication circuitry, and a memory operatively connected with the processor. The memory may store instructions, when executed, causing the processor to receive first data including content from an external electronic device, via the wireless communication circuitry, identify whether first infographics are included in the first data, transmit a message requesting to analyze the first infographics to a server, via the wireless communication circuitry, when the first infographics are included in the first data, receive second data including second infographics corrected from the first infographics, from the server, via the wireless communication circuitry, and display the content including the second infographics, on the display.

In accordance with another aspect of the disclosure, an electronic device is provided. The electronic device may include a display, a wireless communication circuitry, a processor operatively connected with the display and the wireless communication circuitry, and a memory operatively connected with the processor. The memory may store instructions, when executed, causing the processor to receive first data including content from an external electronic device, via the wireless communication circuitry, identify whether first infographics are included in the first data, analyze a distortion rate of the first infographics, when the first infographics are included in the first data, transmit a message requesting to correct the first infographics to a server, via the wireless communication circuitry, when the distortion rate of the first infographics is greater than or equal to a specified threshold, receive second data including second infographics corrected from the first infographics, from the server, via the wireless communication circuitry, and display the content including the second infographics, on the display.

In accordance with another aspect of the disclosure, a method of an electronic device is provided. The method may include receiving first data including content from an external electronic device, identifying whether first infographics are included in the first data, analyzing a distortion rate of the first infographics, when the first infographics are included in the first data, transmitting a message requesting to correct the first infographics to a server, when the distortion rate of the first infographics is greater than or equal to a specified threshold, receiving second data including second infographics corrected from the first infographics, from the server, and displaying the content including the second infographics.

### Advantageous Effects

According to embodiments disclosed in the disclosure, the electronic device may provide the user with accurate information by correcting infographics provided from the external electronic device.

According to embodiments disclosed in the disclosure, the electronic device may provide the user with more accurate content based on reliability of the external electronic device which provides infographics.

In addition, various effects ascertained directly or indirectly through the disclosure may be provided.

### DESCRIPTION OF DRAWINGS

FIG. 1 is a block diagram illustrating an electronic device in a network environment according to various embodiments;

FIG. 2 illustrates an operation of displaying corrected infographics according to various embodiments;

FIG. 3 illustrates an operation of displaying infographics before being corrected based on a user input according to various embodiments;

FIG. 4 illustrates a signal sequence diagram of an electronic device which provides corrected infographics and a server according to various embodiments;

FIG. 5 illustrates another signal sequence diagram of an electronic device which provides corrected infographics and a server according to various embodiments;

FIG. 6 illustrates a plurality of content according to various embodiments;

FIG. 7 illustrates an operational flowchart of an electronic device for identifying infographics according to various embodiments;

FIG. 8 illustrates an operational flowchart of analyzing a distortion rate of infographics according to various embodiments;

FIG. 9 illustrating a user interface (UI) indicating reliability of an external electronic device on a running screen of a web browser according to various embodiments;

FIG. 10 illustrating a UI indicating reliability of an external electronic device on a running screen of a message application according to various embodiments;

FIG. 11 illustrating a UI indicating reliability of an external electronic device on a running screen of an e-mail application according to various embodiments;

FIG. 12 illustrating a UI indicating reliability of an external electronic device on a running screen of an album application according to various embodiments; and

FIG. 13 illustrates an operational flowchart of an electronic device indicating reliability of an external electronic device according to various embodiments.

With regard to description of drawings, the same or similar denotations may be used for the same or similar components.

### MODE FOR INVENTION

Hereinafter, various embodiments of the disclosure may be described with reference to accompanying drawings. However, it should be understood that this is not intended to limit the present disclosure to specific implementation forms and includes various modifications, equivalents, and/or alternatives of embodiments of the present disclosure.

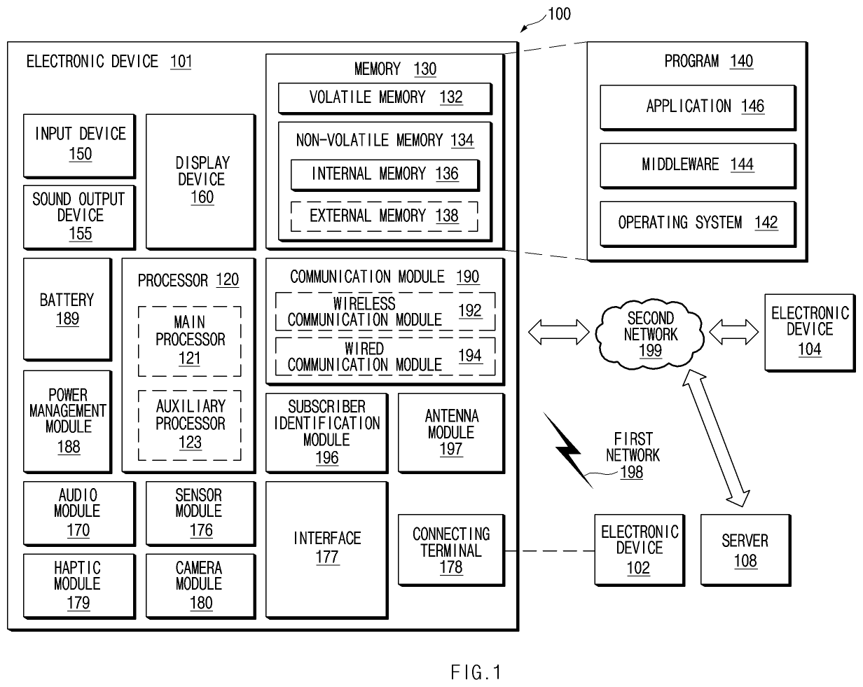

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

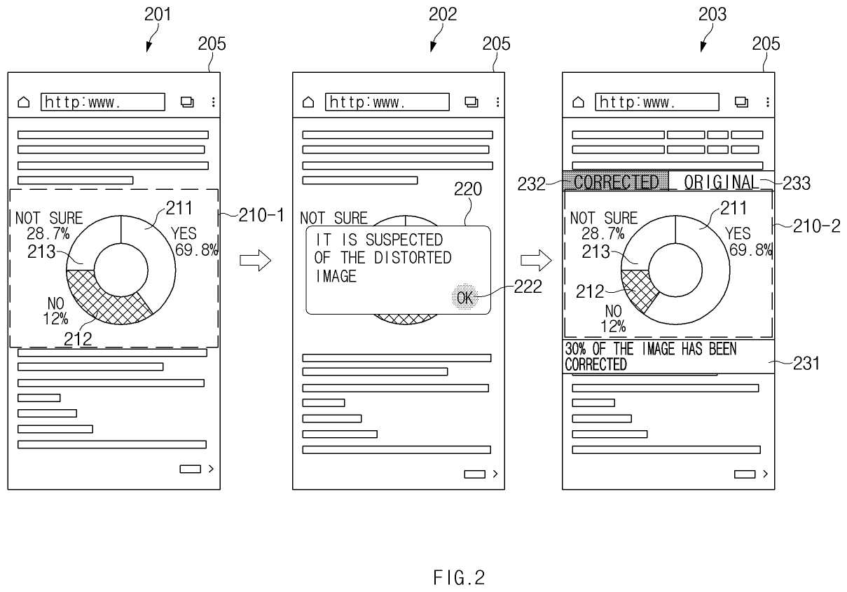

FIG. 2 illustrates an operation of displaying corrected infographics 210-2 according to various embodiments.

Referring to FIG. 2, in operation 201, an electronic device 101 may display a first screen 205 on a display (e.g., at least a part of a display device 160 of FIG. 1), based on data received from an external electronic device (e.g., at least one of an electronic device 102, an electronic device 104, or a server 108 of FIG. 1). The first screen 205 may indicate, for example, content including infographics 210-1. The content may include at least one of, for example, a web page, a message (e.g., at least one of messages through a short message service (SMS), a multimedia message service (MIMS), a messenger, or a social network service (SNS)), an e-mail, or a gallery (or an image album).

According to an embodiment, the data received from the external electronic device may include a data value about a plurality of items (e.g., ‘YES’, ‘NO’, and ‘NOT SURE’). For example, when the data includes statistics associated with survey results, a data value of a first item (e.g., ‘YES’) may be 69.8%, a data value of a second item (e.g., ‘NO’) may be 12%, and a data value of a third item (e.g., ‘NOT SURE’) may be 28.7%.

According to an embodiment, the infographics 210-1 may represent the data value of each of the plurality of items as a figure including at least one of a bar, a circle, a line, or a polygon. For example, the infographics 210-1 may include a first figure 211 corresponding to the first item, a second figure 212 corresponding to the second item, and a third figure 213 corresponding to the third item. FIG. 2 illustrates the infographics 210-1 displayed as a pie graph, but the infographics 210-1 may be formed with various types of figures (e.g., a bar graph or a broken-line graph) capable of visually indicating a data value other than the pie graph.

According to an embodiment, the electronic device 101 may detect whether the infographics 210-1 are distorted information. For example, the electronic device 101 may compare data values with a feature of the figure forming the infographics 210-1 and may identify whether a similarity between the data values with the feature of the figure is less than a specified threshold (e.g., 90%) based on the compared result value. The feature of the figure may include at least one of, for example, a size, an area, a height, an arrangement interval, or an arrangement order of the figure. When the similarity is less than the specified threshold, a distortion rate of the infographics 210-1 may refer to being greater than or equal to the threshold (e.g. 10%). When the distortion rate of the infographics 210-1 is greater than or equal to the threshold, the electronic device 101 may determine that the infographics 210-1 are distorted.

For example, when the data value of the first item (e.g., ‘YES’) is 69.8%, the data value of the second item (e.g., ‘NO’) is 12%, and the data value of the third item (e.g., ‘NOT SURE’) is 28.7%, whereas the ratio of sizes of the first figure 211, the second figure 212, and the third figure 213 is 1:1:1, the electronic device 101 may determine that the infographics 210-1 are distorted. Because the more the distortion rate of the infographics 210-1 increases, the more the accuracy of a data value (or statistics) to be actually provided to a user decreases, visual confusion may be caused to the user.

When the distortion rate of the infographics 210-1 is greater than or equal to the specified threshold, in operation 202, the electronic device 101 may display a UI 220 indicating a distortion of the infographics 210-1 within the first screen 205. The UI 220 may include a first object 222 for receiving a response from the user.

When receiving a user input selecting the first object 222, in operation 203, the electronic device 101 may display corrected infographics 210-2 within the first screen 205. For example, the ratio of the sizes of the first figure 211, the second figure 212, and the third figure 213 may be corrected to correspond to the data value of the first item, the data value of the second item, and the data value of the third item (e.g., 69.8:12:28.7).

According to an embodiment, the electronic device 101 may display a UI 231 (e.g., ‘30% of the image has been corrected.’) for indicating that the infographics 210-1 are corrected on one region of the first screen 205 (e.g., a lower end of the corrected infographics 210-2).

According to an embodiment, the electronic device 101 may display a second object 232 and a third object 233 on one region of the first screen 205 (e.g., an upper end of the corrected infographics 210-2) such that the user visually compares the infographics 210-1 before being corrected with the corrected infographics 210-2. When a user input selecting the third object 233 is received, the electronic device 101 may display the infographics 210-1 before being corrected. When a user input selecting the second object 232 is received, the electronic device 101 may display the corrected infographics 210-2.

To correct the infographics 210-1, the electronic device 101 may perform the following operation.

1) Operation of identifying whether infographics are included in data received from an external electronic device

2) Operation of identifying whether the distortion rate of the infographics is greater than or equal to the specified threshold

3) Operation of correcting the infographics

According to an embodiment, the electronic device 101 may request at least one of 1) to 3) operations from a server. For example, to reduce the load amount of hardware (e.g., a processor 120 of FIG. 1) or software (e.g., an application 146 of FIG. 1) required to correct the infographics 210-1, when it is identified that the infographics are included in the received data, the electronic device 101 may request analysis and correction (e.g., operation 2) and operation 3)) of the distortion rate of the infographics 210-1 from the server. For another example, to reduce wireless data transfer traffic, the electronic device 101 may directly analyze a distortion rate of the infographics 210-1 and may request the server to correct the infographics 210-1 only when the distortion rate of the infographics 210-1 is greater than or equal to the specified threshold. According to an embodiment, the server may be the same entity as the external electronic device, may be at least a part of the external electronic device, or may be an entity independent of the external electronic device.

According to an embodiment, the electronic device 101 may perform operations 1) to 3) before operation 201 of FIG. 2, between operation 201 and operation 202, or between operation 202 and operation 203, and may separately perform each of operations 1) to 3) before operation 201, between operation 201 and operation 202, or between operation 202 and operation 203.

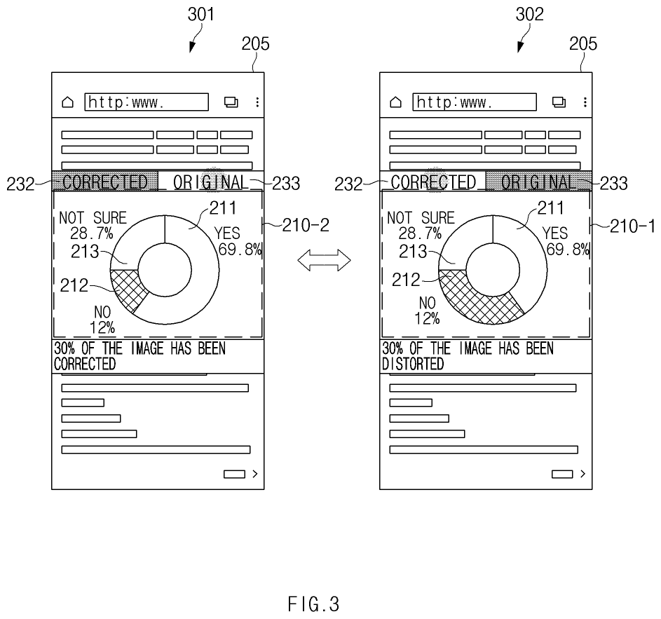

FIG. 3 illustrates an operation of displaying infographics 210-1 before being corrected based on a user input according to various embodiments.

Referring to FIG. 3, a first screen 205 displayed in operation 301 may correspond to the first screen 205 displayed in operation 203 of FIG. 2. In operation 301, the electronic device 101 may receive a user input selecting a third object 233 while corrected infographics 210-2 are displayed. In response to the user input, the electronic device 101 may perform operation 302. In operation 302, the electronic device 101 may change the corrected infographics 210-2 to infographics 210-1 before being corrected. According to an embodiment, while the infographics 210-1 before being corrected are displayed, when a user input selecting a second object 232 is received, the electronic device 101 may perform operation 301. In operation 301, the electronic device 101 may change the infographics 210-1 before being corrected to the corrected infographics 210-2. Through the above-mentioned method, the electronic device 101 may allow a user to visually compare the infographics 210-1 before being corrected with the corrected infographics 210-2.

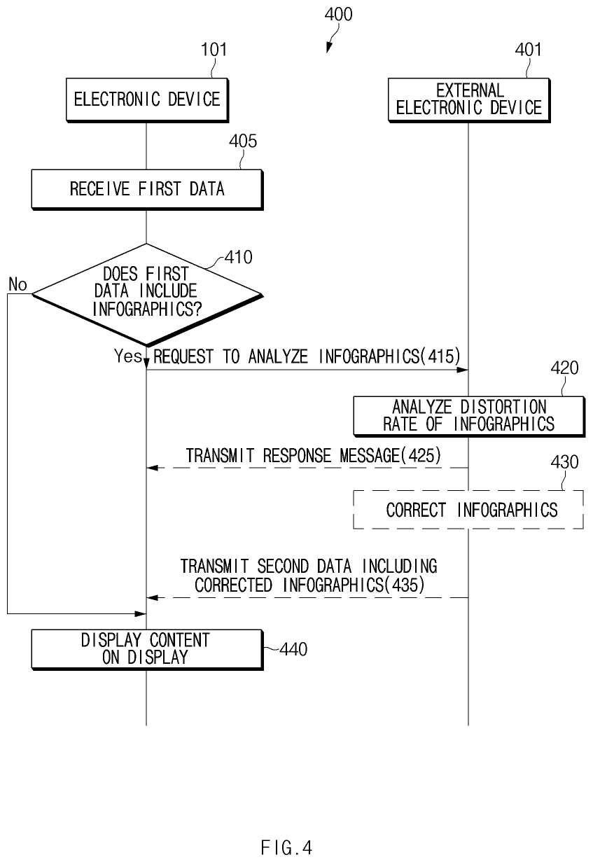

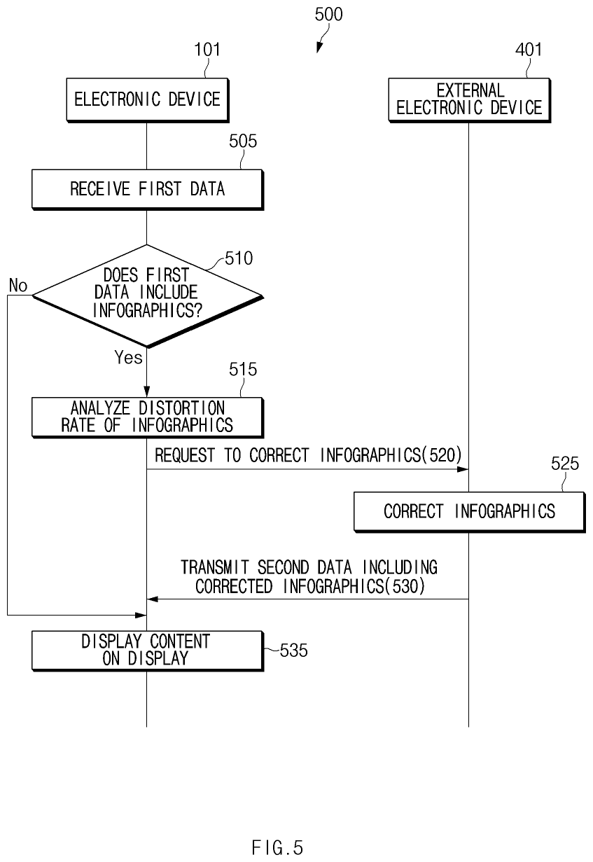

FIGS. 4 and 5 illustrate signal sequence diagrams of an electronic device 101 which provides corrected infographics 210-2 and a server 401 according to various embodiments. FIG. 4 illustrates an embodiment where an electronic device 101 performs only operation 1) among operations 1) to 3) of FIG. 2. FIG. 5 illustrates an embodiment where an electronic device 101 performs operation 1) and operation 2).

Referring to FIG. 4, in operation 405 of a signal sequence diagram 400, an electronic device 101 may receive first data including content from an external electronic device (e.g., at least one of an electronic device 102, an electronic device 104, or a server 108 of FIG. 1). When the server 401 may is the same entity as the external electronic device or is at least a part of the external electronic device, the electronic device 101 may receive the first data from the server 401.

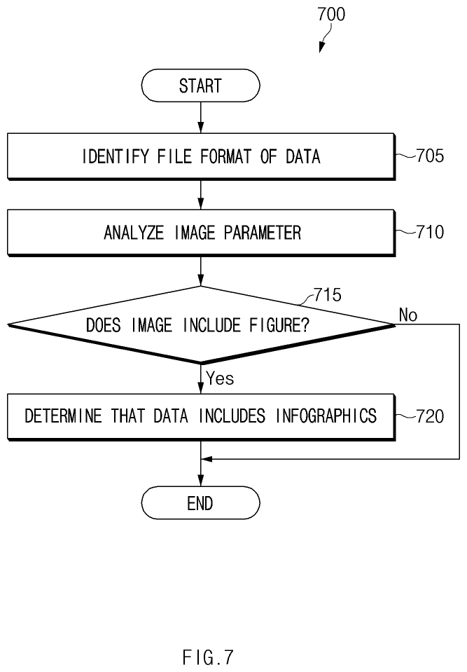

In operation 410, the electronic device 101 may identify whether the first data includes infographics. According to an embodiment, the electronic device 101 may identify whether the first data includes the infographics by analyzing an image included in the first data using machine learning. An embodiment of the operation of identifying whether the first data includes the infographics will be described below in FIG. 7. When the first data does not include the infographics, in operation 440, the electronic device 101 may display content, which does not include the infographics, on a display.

When the first data includes the infographics, in operation 415, the electronic device 101 may transmit a message requesting to analyze the infographics to the server 401 via a wireless communication circuitry (e.g., at least a part of a wireless communication module 192 of FIG. 1).

According to an embodiment, the message requesting to analyze the infographics may include link information for accessing the infographics or the first data. For example, when the content includes a web page, the link information may include a uniform resource locator (URL) address. For another example, when the content includes a message, the link information may further include identification information (e.g., a phone number) of the external electronic device. For another example, when the content is an e-mail, the link information may further include a mail address of the external electronic device.

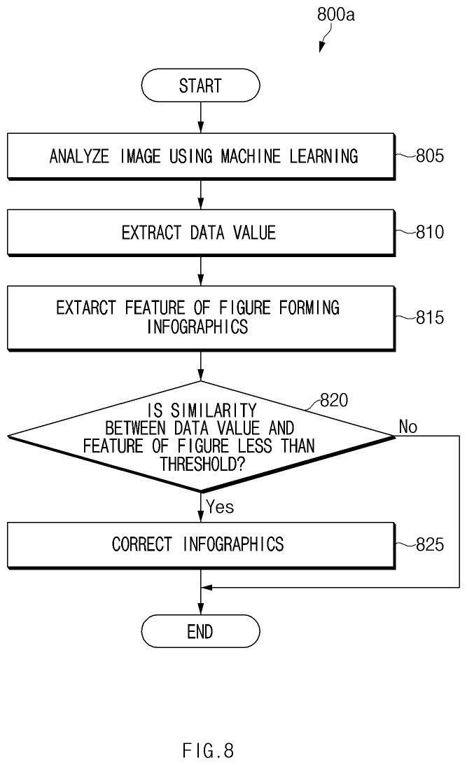

In operation 420, the server 401 may analyze a distortion rate of the infographics. For example, the server 401 may identify whether the distortion rate of the infographics is greater than or equal to a specified threshold. An embodiment of the operation of analyzing the distortion rate of the infographics will be described below in FIG. 8.

When the distortion rate of the infographics is less than the specified threshold, the server 401 may fail to perform operation 430 and operation 435 and, in operation 425, may transmit a response message indicating that the distortion rate of the infographics is less than the specified threshold to the electronic device 101. In response to the reception of the response message, the electronic device 101 may display content where infographics are not corrected on the display.

When the distortion rate is greater than or equal to the specified threshold, the server 401 may perform operation 430 and operation 435 without performing operation 425. In operation 430, the server 401 may correct the infographics. According to an embodiment, the server 401 may correct the infographics based on the distortion rate of the infographics. According to an embodiment, the server 401 may correct the infographics by converting an image of a figure forming the infographics. For example, the server 401 may enlarge a size of the image using an interpolation. For another example, the server 401 may reduce the size of the image or may rotate the image by a specified angle.

In operation 435, the server 401 may transmit second data including the corrected infographics to the electronic device 101. When the second data is received, in operation 440, the electronic device 101 may display content including the corrected infographics on the display.

Referring to FIG. 5, in operation 505 of a signal sequence diagram 500, the electronic device 101 may receive first data including content from the external electronic device (or the server 401). In operation 510, the electronic device 101 may identify whether the first data includes infographics. When the first data does not include the infographics, in operation 535, the electronic device 101 may display content, which does not include the infographics, on the display.

When the first data includes the infographics, in operation 515, the electronic device 101 may directly analyze a distortion rate of the infographics to reduce wireless data transfer traffic. According to an embodiment, the electronic device 101 may analyze the distortion rate of the infographics based on the same or similar principle to operation 420 of FIG. 4.

When the distortion rate of the infographics is greater than or equal to a specified threshold, in operation 520, the electronic device 101 may request the server 401 to correct the infographics. According to an embodiment, the message requesting to correct the infographics may include link information for accessing the infographics or data. According to an embodiment, the message requesting to correct the infographics may include information associated with the analyzed distortion rate.

In operation 525, the server 401 may correct the infographics. In operation 530, the server 401 may transmit second data including the corrected infographics to the electronic device 101. When the second data is received, in operation 535, the electronic device 101 may display content including the corrected infographics on the display.

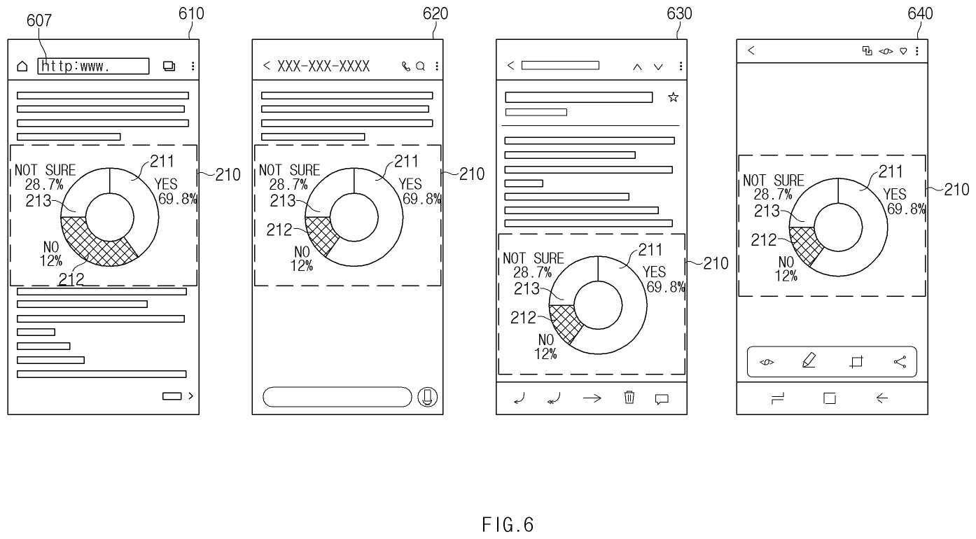

FIG. 6 illustrates a plurality of content according to various embodiments.

Referring to FIG. 6, content may include at least one of a web page, a message, an e-mail, or a gallery.

For example, when running a web browser application, an electronic device 101 may display a first screen 610 including a web page on its display. The first screen 610 may include, for example, a search bar 607 and infographics 210 (e.g., infographics 210-1 of FIG. 2). The electronic device 101 may insert a URL address into a message requesting to analyze or correct the infographics 210.

For another example, when receiving a message from an external electronic device, the electronic device 101 may display a second screen 620 on the display. The second screen 620 may include, for example, a running screen of a message application (e.g., at least one of an SMS, an MIMS, a messenger, or an SNS application). According to an embodiment, the second screen 620 may include the infographics 210 together with contents of the received message. When the distortion of the infographics 210 is detected, the electronic device 101 may insert an identification number (e.g., a phone number) of the external electronic device into the message requesting to analyze or correct the infographics 210.

For another example, when receiving an e-mail from the external electronic device, the electronic device 101 may display a third screen 630 on the display. The third screen may include, for example, a running screen of an e-mail application. According to an embodiment, the third screen 630 may include the infographics 210 together with contents of the received e-mail. When the distortion of the infographics 210 is detected, the electronic device 101 may insert a mail address of the external electronic device into the message requesting to analyze or correct the infographics 210.

For another example, when receiving an image from the external electronic device or when receiving a user input running a gallery application (or an image album application), the electronic device 101 may display a fourth screen 640 including at least one image on the display. According to an embodiment, the at least one image may include the infographics 210.

FIG. 7 illustrates an operational flowchart of an electronic device for identifying infographics according to various embodiments. Hereinafter, operations shown in FIG. 7 or another operational flowchart may be performed by an electronic device 101 or a component of the electronic device 101. The component of the electronic device 101 may include at least one of, for example, a hardware configuration (e.g., a processor 120) or a software configuration (e.g., an application layer 146 or middleware 144) among components shown in FIG. 1. Operations shown in FIG. 7 may be an embodiment of operation 410 of FIG. 4 or operation 510 of FIG. 5.

Referring to FIG. 7, in operation 705 of an operational flowchart 700, the electronic device 101 may identify a file format of received data (e.g., first data of FIG. 4 or 5). For example, the electronic device 101 may identify whether the received data is an image file or includes the image file. A file format indicating the image file may include, for example, jpg, gif, bmp, png, or jpeg.

In operation 710, the electronic device 101 may analyze an image parameter included in the image file. The image file may include at least one of, for example, a pixel, red green blue (RPG), or a histogram.

In operation 715, the electronic device 101 may identify whether an image includes a figure corresponding to at least one of a bar, a circle, a line or a polygon capable of forming a graph based on the analyzed image parameter. According to an embodiment, the electronic device 101 may identify whether the image includes the figure by means of a prediction method based on machine learning. When the image does not include the figure, the electronic device 101 may end the algorithm of FIG. 7 and may display content which does not include infographics.

When the image includes the figure, in operation 720, the electronic device 101 may determine that data includes the infographics.

FIG. 8 illustrates an operational flowchart of analyzing a distortion rate of infographics according to various embodiments. Operations of FIG. 8 may be an embodiment of operation 420 of FIG. 4 or operation 515 of FIG. 5. The operation of FIG. 8 described below is on the premise that it is performed by an electronic device 101, but the same operation may be performed by a server 401.

Referring to FIG. 8, in operation 805 of an operational flowchart 800a, the electronic device 101 may analyze an image using machine learning. According to an embodiment, operation 805 may be the same or similar in operation principle to operation 710 of FIG. 7.

In operation 810, the electronic device 101 may extract a data value based on an analyzed parameter. The data value may include, for example, a representative value, a range, a name of an item, or a number. For example, in infographics 210-1 of FIG. 2, a representative value of a first item (e.g., ‘YES’) may be 69.8%, a representative value of a second item (e.g., ‘NO’) may be 12%, and a representative value of a third item (e.g., ‘NOT SURE’) may be 28.7%.

In operation 815, the electronic device 101 may extract a feature of a figure forming infographics based on the analyzed parameter. The feature of the figure may include at least one of, for example, a size, an area, a height, an arrangement interval, or an arrangement order of the figure. For example, in the infographics 210-1 of FIG. 2, the ratio of sizes of a first figure 211 corresponding to the first item, a second figure 212 corresponding to the second item, and the third figure 213 corresponding to the third item may be 1:1:1.

In operation 820, the electronic device 101 may identify whether a similarity between the extracted data value and the extracted feature of the figure is less than a specified threshold. Because when the similarity is greater than or equal to the specified threshold means that a distortion rate of infographics is less than the specified threshold, the electronic device 101 may end the algorithm of FIG. 8.

When the similarity is less than the specified threshold, because the distortion rate of the infographics is greater than or equal to the threshold value, in operation 825, the electronic device 101 may correct the infographics. For example, in FIG. 2, it may be assumed that the electronic device 101 sets a threshold for the distortion rate of the infographics to 10%. Because the ratio of representative values of the first item, the second item, and the third item is 69.8:12.0:18.2, whereas the ratio of sizes of the first figure 211, the second figure 212, and the third figure 213 is 1:1:1, the distortion rate may be above the threshold, 10%.

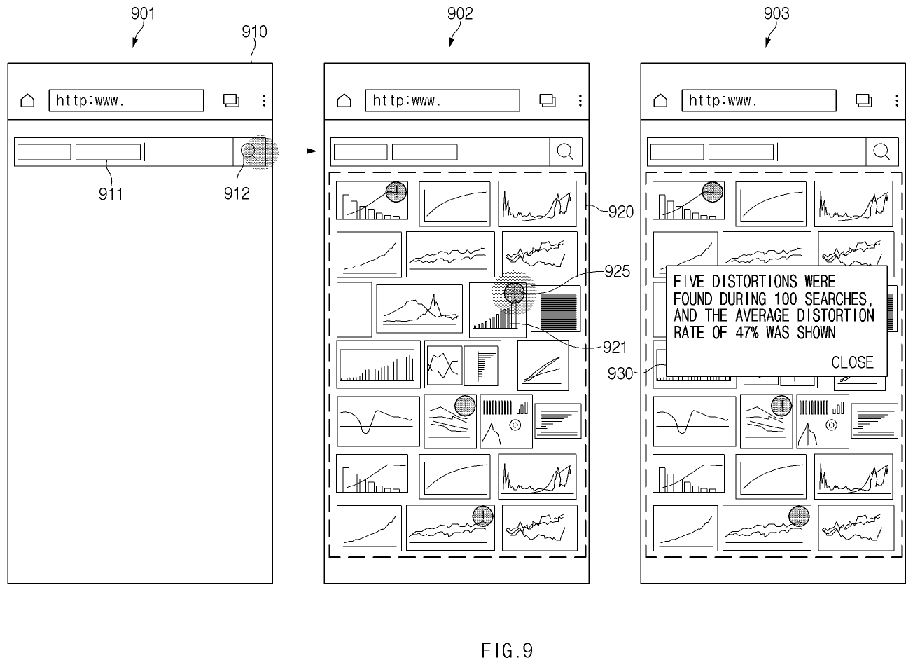

FIG. 9 illustrating a UI indicating reliability of an external electronic device on a running screen of a web browser according to various embodiments.

According to an embodiment, reliability may include reliability of the external electronic device which transmits data. The reliability of the external electronic device may include, for example, at least one of the number of times that the external electronic device transmits infographics, a distortion rate of which is less than a threshold, or an average distortion rate.

Referring to FIG. 9, in operation 901, an electronic device 101 may display a first screen 910 including a web page on its display. The first screen 910 may include, for example, a search bar 911 displaying text input by a user and a search button 912 for executing a search. When a user input selecting the search button 912 is received, the electronic device 101 may perform operation 902.

In operation 902, the electronic device 101 may display thumbnails of a plurality of infographics on a region 920 forming a portion of the first screen 910 based on a search result. According to an embodiment, the electronic device 101 may identify at least one infographics provided by the external electronic device, reliability of which is less than the specified threshold, among the plurality of infographics based on distortion rate history information stored in the electronic device 101. The distortion rate history information may include at least one of, for example, a distortion rate of previous infographics (e.g., infographics 210-1 of FIG. 2) provided from the external electronic device, the number of times that the external electronic device transmits infographics, a distortion rate of which is less than the threshold, or identification information (e.g., a URL address, a phone number, or an e-mail address) of the external electronic device. According to an embodiment, the electronic device 101 may store or update the distortion rate history information in a memory (e.g., a memory 130 of FIG. 1) of the electronic device 101 using machine learning. For another example, the electronic device 101 may store the distortion rate history information in a separate server (e.g., a cloud server or a server 401).

According to an embodiment, the electronic device 101 may display an indicator 925 on a thumbnail (e.g., 921) of at least one infographics where the reliability of the external electronic device is less than the specified threshold. The indicator 925 may indicate that the reliability of the external electronic device which provides displayed infographics is less than the specified threshold.

According to an embodiment, in response to a user input selecting the indicator 925, in operation 903, the electronic device 101 may display a pop-up window 930 indicating the reliability of the external electronic device which provides selected infographics. For example, when the number of times that the external electronic device which provides infographics corresponding to the thumbnail 921 provides the infographics to the electronic device 101 is 100, when the electronic device 101 finds 5 distortions of the infographics among 100, and when an average distortion rate of the found distortions is 47%, the pop-up window 930 may include the text “Five distortions were found during 100 searches, and the average distortion rate of 47% was shown.” The electronic device 101 may provide the user with reliable information by displaying a UI including the indicator 925 and the pop-up window 930.

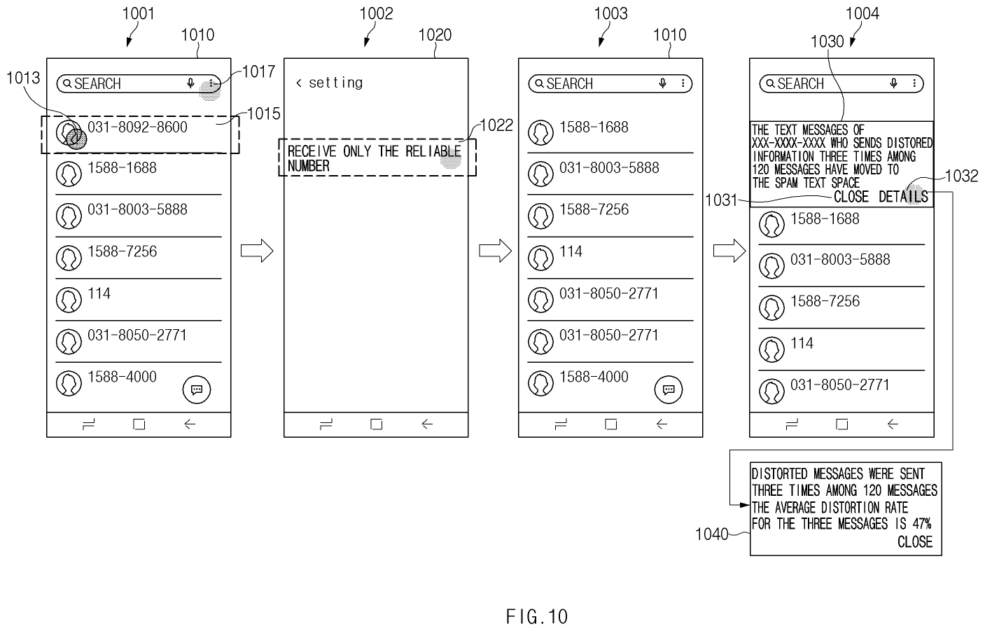

FIG. 10 illustrating a UI indicating reliability of an external electronic device on a running screen of a message application according to various embodiments.

Referring to FIG. 10, in response to a user input running the message application, in operation 1001, an electronic device 101 may display a second screen 1010 on its display. The second screen 1010 may include, for example, a list of message information received from a plurality of external electronic devices. According to an embodiment, the electronic device 101 may identify an external electronic device, reliability of which is less than a specified threshold, among the plurality of external electronic devices which transmit a plurality of messages based on distortion rate history information. The electronic device 101 may display an indicator 1013 on message information (e.g., 1015) of the external electronic device, the reliability of which is less than the specified threshold. The indicator 1013 may indicate the same or similar information to an indicator 925 of FIG. 9. For example, although not illustrated in FIG. 10, when a user input selecting the indicator 1013 is received, the electronic device 101 may display a separate pop-up window (e.g., a pop-up window 930 of FIG. 9) indicating reliability of the external electronic device which provides the selected message information 1015.

According to an embodiment, the electronic device 101 may block a message of the external electronic device, the reliability of which is less than the threshold, based on the user input. For example, the electronic device 101 may receive a user input selecting a setting button 1017 displayed on one region of the second screen 1010. In response to the user input, in operation 1020, the electronic device 101 may display a configuration screen 1020. While the configuration screen 1020 is displayed, the electronic device 101 may receive a user input selecting a button 1022 setting to receive only a reliable number. In response to the user input, the electronic device 101 may release the displaying of the message information 1015 on the second screen 1010. When a message is received from the external electronic device, the reliability of which is less than the threshold, the electronic device 101 may fail to display message information of the received message.

According to an embodiment, when the message is received, rather than not displaying the message information 1015, in operation 1004, the electronic device 101 may display a first pop-up window 1030 notifying a user of the reception of the message on the second screen 1010. The first pop-up window 1030 may include a first object 1031 for closing the first pop-up window 1030 and a second object 1032 for indicating reliability of the external electronic device in more detail. When a user input selecting the second object 103 is received, the electronic device 101 may display the second pop-up window 1040. The second pop-up window 1040 may correspond to, for example, a pop-up window 930 of FIG. 9.

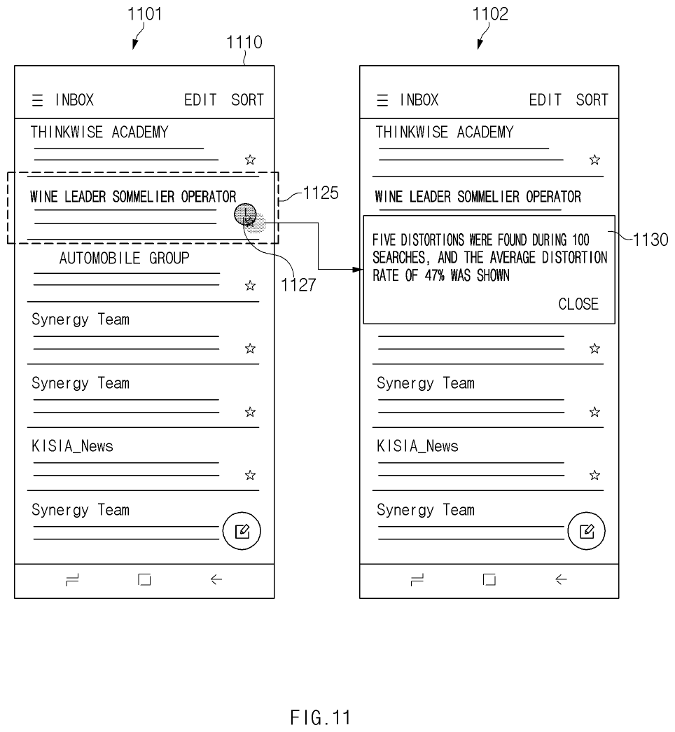

FIG. 11 illustrating a UI indicating reliability of an external electronic device on a running screen of an e-mail application according to various embodiments.

Referring to FIG. 11, in response to a user input running the e-mail application, in operation 1001, an electronic device 101 may display a third screen 1110 on its display. The third screen 1110 may include, for example, a list of e-mail information received from a plurality of external electronic devices. According to an embodiment, the electronic device 101 may identify an external electronic device, reliability of which is less than a specified threshold, among the plurality of external electronic devices which transmit a plurality of e-mails based on distortion rate history information. The electronic device 101 may display an indicator 1127 on e-mail information (e.g., 1125) of the external electronic device, the reliability of which is less than the specified threshold. The indicator 1127 may indicate the same or similar information to an indicator 925 of FIG. 9. For example, when a user input selecting the indicator 1127 is received, in operation 1102, the electronic device 101 may display a separate pop-up window 1130 indicating the reliability of the external electronic device which provides the selected e-mail information 1125 on one region of the third screen 1110.

Although not illustrated in FIG. 11, the electronic device 101 may block an e-mail of the external electronic device, the reliability of which is less than the specified threshold. For example, the electronic device 101 may receive a user input blocking an e-mail of the external electronic device, the reliability of which is less than the specified threshold, on a configuration screen (e.g., a configuration screen 120 of FIG. 10). In response to the user input, the electronic device 101 may release the displaying of the e-mail information 1125 on the third screen 1110. When an e-mail is received from the external electronic device, the reliability of which is less than the threshold, the electronic device 101 may fail to display e-mail information of the received e-mail.

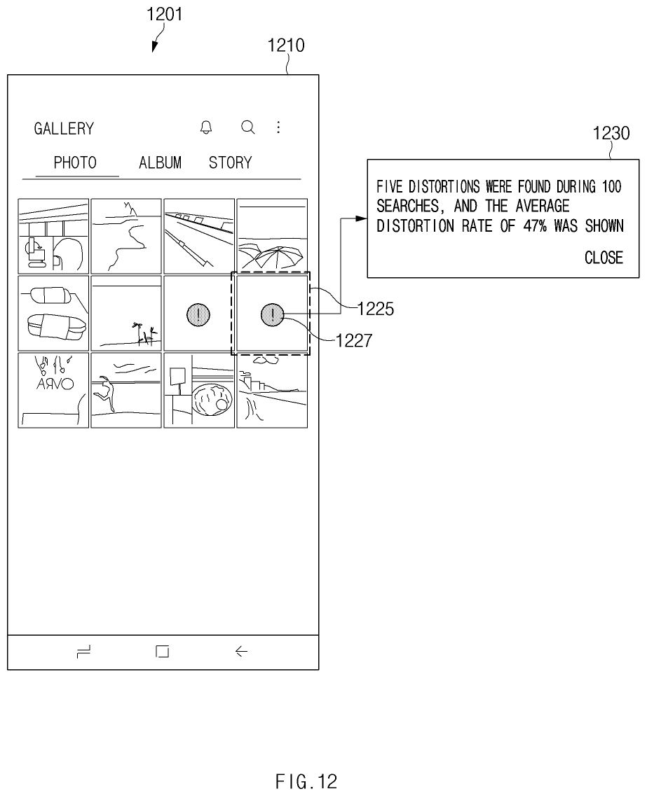

FIG. 12 illustrating a UI indicating reliability of an external electronic device on a running screen of an album application according to various embodiments.

Referring to FIG. 12, in response to a user input running a gallery application (or an image album application), in operation 1201, an electronic device 101 may display a fourth screen 1210 on its display. The fourth screen 1210 may include, for example, a plurality of images. At least one of the plurality of images may be received from an external electronic device. At a portion of the at least one image received from the external electronic device may include infographics. According to an embodiment, the electronic device 101 may identify an external electronic device, reliability of which is less than a specified threshold, among the plurality of external electronic devices which transmit images based on distortion rate history information. The electronic device 101 may display an indicator 1127 on image information (e.g., 1225) transmitted by the external electronic device, the reliability of which is less than the specified threshold. The indicator 1227 may indicate the same or similar information to an indicator 925 of FIG. 9. For example, when a user input selecting the indicator 1227 is received, the electronic device 101 may display a separate pop-up window 1230 indicating the reliability of the external electronic device which provides the selected image information 1225 on one region of the fourth screen 1210.

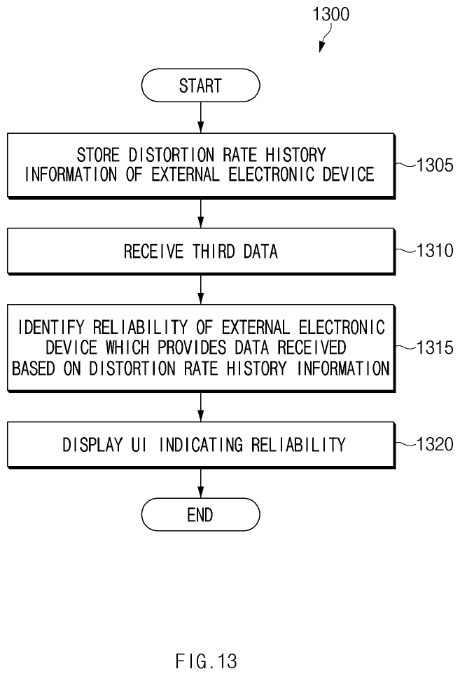

FIG. 13 illustrates an operational flowchart of an electronic device 101 indicating reliability of an external electronic device according to various embodiments. Operations shown in FIG. 13 may be performed after operation 435 of FIG. 4 or operation 530 of FIG. 5.

Referring to FIG. 13, in operation 1305 of an operational flowchart 1300, the electronic device 101 may store distortion rate history information of an external electronic device. For example, second data (e.g., operation 435 of FIG. 4 or operation 530 of FIG. 5) received from a server 401 may include information associated with a distortion rate of infographics together with corrected infographics. The information associated with the infographics may indicate, for example, what % the distortion rate of the infographics is. The electronic device 101 may generate distortion rate history information of the external electronic device which provides first data (e.g., operation 405 of FIG. 4 or operation 505 of FIG. 5) based on the information associated with the distortion rate. According to an embodiment, the electronic device 101 may periodically update the distortion rate history information using machine learning. The electronic device 101 may store the distortion rate history information in a memory of the electronic device 101 or a separate cloud server (e.g., the server 401).

In operation 1310, the electronic device 101 may receive third data from the external electronic device. Transmitting the third data, the external electronic device may be the same entity as the external electronic device which transmits the first data. Content or infographics included in the third data may differ from at least a portion of content or infographics included in the first data.

In response to receiving the third data, in operation 1315, the electronic device 101 may identify reliability of the external electronic device which provides the third data based on the distortion rate history information. For example, the electronic device 101 may identify at least one of the number of times that the external electronic device transmits infographics, a distortion rate of which is less than a threshold, or an average distortion rate.

In operation 1320, the electronic device 101 may display a UI indicating reliability of the external electronic device on the display. For example, the electronic device 101 may display an indicator (e.g., an indicator 925 of FIG. 9) indicating that the reliability of the external electronic device which provides infographics is less than the specified threshold or a pop-up window (e.g., a pop-up window 930 of FIG. 9) indicating the reliability of the external electronic device.

As described above, an electronic device (e.g., an electronic device 101 of FIG. 1) may include a display (e.g., at least a portion of a display device 160 of FIG. 1), a wireless communication circuitry (e.g., at least a part of a wireless communication module of FIG. 1), a processor (e.g., a processor 120 of FIG. 1) operatively connected with the display and the wireless communication circuitry, and a memory (e.g., a memory 130 of FIG. 1) operatively connected with the processor. The memory may store instructions, when executed, causing the processor to receive first data including content from an external electronic device, via the wireless communication circuitry, identify whether first infographics (e.g., infographics 210-1 of FIG. 2) are included in the first data, transmit a message requesting to analyze the first infographics to a server (e.g., a server 410 of FIG. 4), via the wireless communication circuitry, when the first infographics are included in the first data, receive second data including second infographics (e.g., infographics 210-2 of FIG. 2) corrected from the first infographics, from the server, via the wireless communication circuitry, and display the content including the second infographics, on the display.

According to an embodiment, the content may include at least one of a web page, a message, an e-mail, or a gallery.

According to an embodiment, the instructions may cause the processor to display a first UI (e.g., a UI 220 of FIG. 2) indicating a distortion of the first infographics, on the display and display the second infographics, on the display, in response to a user input selecting the first UI.

According to an embodiment, the instructions may cause the processor to display a second UI (e.g., a third object 233 of FIG. 2) for displaying the first infographics together with the first UI, on the display, receive a user input selecting the second UI, in a state where the second infographics are displayed, and change the displayed second infographics to the first infographics, on the display.

According to an embodiment, the instructions may cause the processor to identify a file format of the first data, analyze a parameter of an image file, when the file format of the first data is the image file, identify whether the image file includes at least one of a bar, a circle, a line, or a polygon capable of forming a graph based on the analyzed parameter, and determine that the first data includes the first infographics, when the image file includes the at least one of the bar, the circle, the line, or the polygon capable of forming the graph.

According to an embodiment, the instructions may cause to processor to analyze the parameter of the image file, using machine learning.

According to an embodiment, the second data may further include information associated with a distortion rate of the first infographics. The instructions may cause the processor to generate distortion rate history information of the external electronic device, based on the information associated with the distortion rate of the first infographics and store the distortion rate history information in the memory.

According to an embodiment, the instructions may cause the processor to receive third data including third infographics from the external electronic device, via the wireless communication circuitry and display a UI (e.g., an indicator 925 or a pop-up window 930 of FIG. 9) indicating reliability of the external electronic device, based on the distortion rate history information, on the display.

As described above, an electronic device (e.g., an electronic device 101 of FIG. 1) may include a display (e.g., at least a portion of a display device 160 of FIG. 1), a wireless communication circuitry (e.g., at least a part of a wireless communication module of FIG. 1), a processor (e.g., a processor 120 of FIG. 1) operatively connected with the display and the wireless communication circuitry, and a memory (e.g., a memory 130 of FIG. 1) operatively connected with the processor. The memory may store instructions, when executed, causing the processor to receive first data including content from an external electronic device, via the wireless communication circuitry, identify whether first infographics (e.g., infographics 210-1 of FIG. 2) are included in the first data, analyze a distortion rate of the first infographics, when the first infographics are included in the first data, transmit a message requesting to correct the first infographics to a server (e.g., a server 410 of FIG. 4), via the wireless communication circuitry, when the distortion rate of the first infographics is greater than or equal to a specified threshold, receive second data including second infographics (e.g., infographics 210-2 of FIG. 2) corrected from the first infographics, from the server, via the wireless communication circuitry, and display the content including the second infographics, on the display.

According to an embodiment, the content may include at least one of a web page, a message, an e-mail, or a gallery.

According to an embodiment, the instructions may cause the processor to identify a file format of the first data, analyze a parameter of an image file, when the file format of the first data is the image file, identify whether the image file includes at least one of a bar, a circle, a line, or a polygon capable of forming a graph based on the analyzed parameter, and determine that the first data includes the first infographics, when the image file includes the at least one of the bar, the circle, the line, or the polygon capable of forming the graph.

According to an embodiment, the instructions may cause the processor to analyze a parameter of the image file, using machine learning.

According to an embodiment, the instructions may cause the processor to analyze a parameter of the image file, using machine learning, identify a data value and a feature of a figure forming the first infographics, based on the analyzed parameter, and determine the distortion rate of the first infographics by comparing the data value with the feature of the figure.

According to an embodiment, the second data may further include information associated with the distortion rate of the first infographics. The instructions may cause the processor to generate distortion rate history information of the external electronic device, based on the information associated with the distortion rate of the first infographics and store the distortion rate history information in the memory.

According to an embodiment, the instructions may cause the processor to receive third data including third infographics from the external electronic device, via the wireless communication circuitry and display a UI (e.g., an indicator 925 or a pop-up window 930 of FIG. 9) indicating reliability of the external electronic device, based on the distortion rate history information, on the display.

As described above, a method of an electronic device (e.g., an electronic device 101 of FIG. 1) may include receiving first data including content from an external electronic device, identifying first infographics (e.g., infographics 210-1 of FIG. 2) are included in the first data, analyzing a distortion rate of the first infographics, when the first infographics are included in the first data, transmitting a message requesting to correct the first infographics to a server (e.g., a server 410 of FIG. 4), when the distortion rate of the first infographics is greater than or equal to a specified threshold, receiving second data including second infographics (e.g., infographics 210-2 of FIG. 2) corrected from the first infographics, from the server, and displaying the content including the second infographics.

According to an embodiment, the identifying of whether the first infographics are included in the first data may include identifying a file format of the first data, analyzing a parameter of an image file, when the file format of the first data is the image file, identifying whether the image file includes at least one of a bar, a circle, a line, or a polygon capable of forming a graph based on the analyzed parameter, and determining that the first data includes the first infographics, when the image file includes the at least one of the bar, the circle, the line, or the polygon capable of forming the graph.

According to an embodiment, the analyzing of the distortion rate of the first infographics may include analyzing a parameter of the image file, using machine learning, identifying a data value and a feature of a figure forming the first infographics, based on the analyzed parameter, and determining the distortion rate of the first infographics by comparing the data value with the feature of the figure.

According to an embodiment, the second data may further include information associated with the distortion rate of the first infographics. The method may further include generating distortion rate history information of the external electronic device, based on the information associated with the distortion rate of the first infographics and storing the distortion rate history information.

According to an embodiment, the method may further include receiving third data including third infographics from the external electronic device and displaying a UI (e.g., an indicator 925 or a pop-up window 930 of FIG. 9) indicating reliability of the external electronic device, based on the distortion rate history information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a display;
a wireless communication circuitry;
a processor operatively connected with the display and the wireless communication circuitry; and
a memory operatively connected with the processor,
wherein the memory stores instructions, when executed, causing the processor to:
receive first data including content from an external electronic device, via the wireless communication circuitry;
identify whether first infographics are included in the first data;
transmit a message requesting to analyze the first infographics to a server, via the wireless communication circuitry, when the first infographics are included in the first data;
receive second data including second infographics corrected from the first infographics, from the server, via the wireless communication circuitry; and
display the content including the second infographics, on the display.

2. The electronic device of claim 1, wherein the content includes at least one of a web page, a message, an e-mail, or a gallery.

3. The electronic device of claim 1, wherein the instructions cause the processor to:
display a first user interface (UI) indicating a distortion of the first infographics, on the display; and
display the second infographics, on the display, in response to a user input selecting the first UI.

4. The electronic device of claim 3, wherein the instructions cause the processor to:
display a second UI for displaying the first infographics together with the first UI, on the display;
receive a user input selecting the second UI, in a state where the second infographics are displayed; and
change the displayed second infographics to the first infographics, on the display.

5. The electronic device of claim 1, wherein the instructions cause the processor to:
identify a file format of the first data;
analyze a parameter of an image file, when the file format of the first data is the image file;
identify whether the image file includes at least one of a bar, a circle, a line, or a polygon capable of forming a graph based on the analyzed parameter; and
determine that the first data includes the first infographics, when the image file includes the at least one of the bar, the circle, the line, or the polygon capable of forming the graph.

6. The electronic device of claim 5, wherein the instructions cause the processor to:
analyze the parameter of the image file, using machine learning.

7. The electronic device of claim 1,
wherein the second data further includes information associated with a distortion rate of the first infographics, and
wherein the instructions cause the processor to:
generate distortion rate history information of the external electronic device, based on the information associated with the distortion rate of the first infographics; and
store the distortion rate history information in the memory.

8. The electronic device of claim 7, wherein the instructions cause the processor to:
receive third data including third infographics from the external electronic device, via the wireless communication circuitry; and
display a UI indicating reliability of the external electronic device, based on the distortion rate history information, on the display.

9. A method of an electronic device, the method comprising:
receiving first data including content from an external electronic device;
identifying whether first infographics are included in the first data;
analyzing a distortion rate of the first infographics, when the first infographics are included in the first data;
transmitting a message requesting to correct the first infographics to a server, when the distortion rate of the first infographics is greater than or equal to a specified threshold;
receiving second data including second infographics corrected from the first infographics, from the server; and
displaying the content including the second infographics.

10. The method of claim 9, wherein the identifying of whether the first infographics are included in the first data includes:
identifying a file format of the first data;
analyzing a parameter of an image file, when the file format of the first data is the image file;
identifying whether the image file includes at least one of a bar, a circle, a line, or a polygon capable of forming a graph based on the analyzed parameter; and
determining that the first data includes the first infographics, when the image file includes the at least one of the bar, the circle, the line, or the polygon capable of forming the graph.

11. The method of claim 10, wherein the analyzing of the parameter of the image file includes:
analyzing the parameter of the image file, using machine learning.

12. The method of claim 11, wherein the analyzing of the parameter of the image file further includes:
identifying a data value and a feature of a figure forming the first infographics, based on the analyzed parameter; and
determining the distortion rate of the first infographics by comparing the data value with the feature of the figure.

13. The method of claim 9, wherein the second data further includes information associated with the distortion rate of the first infographics,
further comprising:
generating distortion rate history information of the external electronic device, based on the information associated with the distortion rate of the first infographics; and
storing the distortion rate history information.

14. The method of claim 13, further comprising:
receiving third data including third infographics from the external electronic device; and
displaying a UI indicating reliability of the external electronic device, based on the distortion rate history information.

15. The method of claim 9, wherein the content includes at least one of a web page, a message, an e-mail, or a gallery.
